(19) United States
(12) Patent Application Publication
(10) Pub. No.: US 2009/0285872 A1
(43) Pub. Date: Nov. 19, 2009

(54) Amphibious Carrier and Method of Manufacturing

(76) Inventor: Lisa Labelle, Fairfield, CA (US)

Correspondence Address: CERMAK KENEALY VAIDYA & NAKAJIMA LLP, 515 EAST BRADDOCK RD SUITE B, Alexandria, VA, 22314, US

(21) Appl. No.: 12/509,247

(22) Filed: Jul. 24, 2009

Related U.S. Application Data
(63) Continuation-in-part of application No. 11/242,847, filed on Oct. 5, 2005.
(60) Provisional application No. 60/578,367, filed on Oct. 6, 2004.

(51) Int. Cl. A01N 25/08; B32B 3/26; A01P 1/00

(52) U.S. Cl. 424/409; 428/314.4

(57) ABSTRACT

An all weather amphibious carrier and method for manufacturing thereof, for use on land and in water, which includes an adjustable strap system for wearing by a person; a foldable body or member adjustably attachable to the strap system and capable of supporting an infant or child upon folding the member and attaching the member to the strap system; the strap system being made of weather-resistant, synthetic, polymerized rubber, a high-strength, resilient synthetic polymer, and a polymer containing polyurethane; and the foldable body member being made of a weather-resistant, synthetic, polymerized rubber, a synthetic fabric made from a polymer containing polyurethane; and a flexible polyurethane open-cell antimicrobial-coated foam. The unique combination of materials keeps the baby/toddler from becoming sweaty when used for land activities, because the materials breathe. When used in water, rain, and snow, it dries quickly, because the water can pass through the through the body if conventional stitching is used or the body can be completely water-tight by using flatlock, breathable seams. The special quilted design also adds extra support, comfort and security for both care-giver/parent and baby, making this carrier ergonomically sound, both on land and in water.

This application is a Continuation-In-Part (CIP) claiming priority under 35 U.S.C. §120 to U.S. patent application Ser. No. 11/242,847 filed on Oct. 5, 2005 which claims priority to U.S. Provisional Patent Application No. 60/578,367 filed on Oct. 6, 2004, both of which are hereby incorporated in their entirety by reference.

### BACKGROUND

1. Technical Field

The present invention relates to an amphibious carrier and a method of manufacturing the carrier, for carrying an infant or child that can be used both in all weather conditions on both land and in water. The present invention also relates to high performance materials which can be used on both land and in the water and which are constructed is such manner that they dry quickly without mildewing or mold.

2. Description of the Related Art

Baby carriers are well known and generally they are designed either for use in dry conditions or for use in water. Generally, these type carriers are designed and made of materials that are suitable for dry use or designed and made of materials primarily for use in water.

Certain baby carriers designed for use in water have been developed. These, however, are not without their drawbacks. Some carriers of this type may be designed for larger babies and not for very small infants.

As well, other front-position baby carriers known on the market, especially some designed for water-use, carry the baby very low on the adult, around the stomach region. Most baby carriers are used for approximately seven months. After that, the baby becomes too heavy for most adults to comfortably carry.

One such carrier is disclosed in U.S. Ser. No. 20050076856 A1 filed on Oct. 29, 2004 and published on Apr. 14, 2005. Although this carrier is designed primarily for use in water, it is not constructed in such a way and is not made of materials that allow it to be used in all weather conditions amphibiously on both land and in water and without mildewing or molding after use in water. Two other infant carriers are made by Body Glove(http://www.bodyglove.com/products/product.php?uselist=showcase&selected-prod=http%3A%2F%2Fbodyglove.mwrc.net%2Fxml%2Fen%2Fproduct.xml%3Fproduct_id %3D5746%26include_offline-products%3Dyes%26include_offline_retailer-s%3Dyes) and WaterTot (http://www.watertot.com/product.asp), and although they use neoprene, on a portion of the strap system and on the seat member of the carrier, they do not use the unique and novel design, construction and combination of materials of the strap system and body of the present invention.

It would be desirable to improve upon the foregoing prior art carriers, and overcome the problems associated with them. It would be especially desirable to provide a versatile all weather amphibious carrier for use on land and in water environments for use with babies and toddlers spanning several years in age.

### SUMMARY

In general, the present invention provides an all weather amphibious carrier, for use on land and in water, which comprises an adjustable strap system for wearing by a person; a foldable member adjustably attachable to the strap system and capable of supporting an infant or child upon folding the member and attaching the member to the strap system; the strap system being made of weather-resistant, synthetic, polymerized rubber, a high-strength, resilient synthetic polymer, and thermoplastic resinous polymers; and the foldable member being made of a weather-resistant, synthetic, polymerized rubber, a synthetic fabric made from a polymer containing polyurethane; and a flexible polyurethane open-cell antimicrobial-coated foam. The unique combination of materials keeps the baby/toddler from becoming sweaty when used for land activities, because the materials breathe. When used in water, rain, and snow, it dries quickly, because the water goes right through the materials. The special design also adds extra support and security for both caregiver/parent and baby, making this carrier ergonomically sound, both in and out of water.

The invention is useful in baby/infant care and recreation, because its unique fabric and construction make it possible for you to keep your baby or toddler close to you, safely and securely, on both land and water. Because of its unique design, construction and materials' properties, the invention is suitable for use in other products where these characteristics are desirable. The materials used and manufacturing technique gives the carrier strength and comfort and as a result the invention is applicable to other items such as snow and winter apparel, beach and sun apparel, diaper bags, beach bags, and physical fitness accessories, such as gym bags and the like.

The carrier of the present invention is versatile, as it can quickly be adjusted to fit all sized adults and babies or toddlers. It can be used with tiny infants lacking the strength to control his/her the neck. The baby can be placed in the carrier to face either in toward the adult or out, facing forward away from the adult, giving the adult safe and complete control of the baby. The carrier is made to be worn in front, although other designs may be constructed. It is simple and easy to put on—the adult just slips strap system shoulder straps onto the shoulders, with the body of the carrier in front. A waist buckle is provided on each side so as to buckle to the buckle piece of each shoulder strap, which can be tightened or loosened as necessary. The body of the carrier is designed to support the baby's head and back, as well as allow freedom of the baby's arms and legs for splashing and kicking when used in the water. The carrier is designed for babies from less than 10 through 35 pounds and at least 21 inches long.

The shoulder straps cross in back, allowing even distribution of weight and support. The combination of specially quilted design and the materials from which the strap system and body are designed and the way they are constructed make the carrier novel, unique, extra comfortable, and ergonomically sound for both care giver/adult and baby/toddler.

When the carrier gets wet, because of the construction and particular materials used, it dries very quickly. Even if it gets dirty, sandy, or muddy, the carrier is completely washable and is cleaned very easily. The secure fit and convenience of hands free ensures safety and comfort.

The invention also provides a high performance material which has a variety of applications. The high performance material may include a top and bottom layer with an insulating layer formed therebetween. The top and bottom layers may be formed from a variety of breathable and non-breathable materials, including neoprene, bamboo, limestone, polyamide, Lycra, cotton and microfibre, as well as various commercial materials including “Klymit,” “Sun Dry Swim™,” materials made by Schoeller and various nano-treated materials, such as Nano-tex™. The top and bottom layers may be waterproof, water resistant or may allow water to flow through. The insulating layer may be constructed from an open or closed cell foam which is treated with antimicrobial agents to prevent the formation of mold and mildew. In one embodiment, the top and bottom layers are constructed from a breathable material and the insulating material is formed from an open cell foam treated with antimicrobial agents. In this embodiment, water flows through the material and the material will not become water logged. Furthermore, the application of antimicrobial agents will prevent the formation of mold and mildew within the material. In another embodiment, the top and bottom layers are formed from a waterproof material with an insulating layer formed from either an open cell or a closed cell material. In this case, the material will resist water and the insulating layer will remain dry. It should be noted that the invention contemplates any combination of the materials described here.

### BRIEF DESCRIPTION OF THE DRAWINGS

The appended drawings form part of the specification hereof. With respect to the drawings, which are not necessarily drawn to scale, the following is briefly noted:

FIG. 1 is a front view depicting an embodiment of a prior art carrier made by Water Tot.

FIG. 2 is a front view of the prior art carrier depicted in U.S. patent application Ser. No. 20050076856 A1.

FIGS. 3 and 3A are a perspective view and a back view respectively of an adult carrying a child in the carrier of the present invention.

FIG. 4 is a front view of the embodiment of the carrier of the present invention shown in FIG. 3.

FIG. 5 is a rear view of the embodiment of the carrier of the present invention shown in FIG. 3.

FIG. 6 is another view of the back straps of the present invention.

FIGS. 6A and 6B show a side view and a three-dimensional view of the shoulder straps of the present invention.

FIG. 7 is a detailed view of the parts of the body of the present invention in which the baby is carried.

FIG. 7A is a detailed side view of the layers making up the main body shown in FIG. 7.

FIG. 8 shows a strap protector that may be used with the carrier. FIG. 9 shows a cross-sectional view of the performance material according to an embodiment of the invention; and

FIG. 10 shows an exploded cross-sectional view of the performance material according to an embodiment of the invention.

### DETAILED DESCRIPTION OF EXEMPLARY EMBODIMENTS

The invention can be further understood by the additional detail set forth below. Such is to be taken in an illustrative and not necessarily limiting sense.

A brief key to some of the features of the carrier embodiments that are depicted in the drawings is set forth as follows:

Number Feature

2, 2′ Carrier shoulder/back straps, made of material layers 50, 52 and 54.

4 Shoulder/back strap stabilizer. p0 6, 6′ Attachment rings, for example, D-rings, attached to shoulder straps 2, 2′ by straps 7, 7′.

8 Main body or member of carrier, made of material layers 54, 56, 58, and 60.

10 Head support for child on upper portion of main body.

12, 12′ Upper tabs on main body.

14, 14′ Lower tabs on main body.

17 Waist strap.

18, 18′ Waist strap buckles.

20, 20′ Back strap buckle ends.

22, 22′ Body upper tab swivel hooks.

23, 23′ Upper tab straps.

24, 24′ Body lower tab buckles.

24A, 24A′ Body lower tab straps.

25, 25′ Velcro tabs on lower tabs 14, 14′.

27 Lower portion of main body 8.

30, 30′ Tabs on lower end of straps 2, 2′ with velcro and buckles

32, 32′ Velcro tabs on the ends of tabs 30, 30′.

34, 34′ Buckle ends on the ends of tabs 30, 30′.

62 Main body stitching forming quilted portions 63 of body 8.

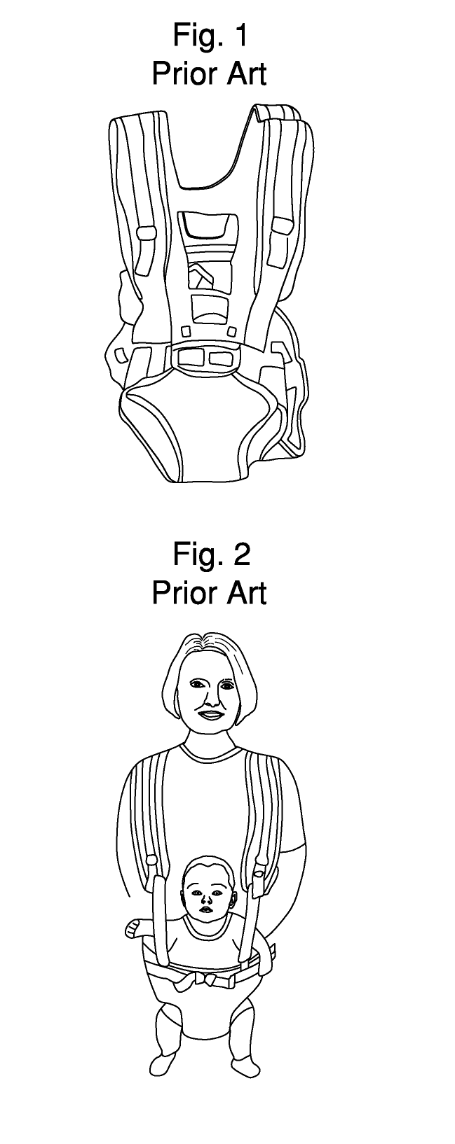

With further reference to the drawings, the carriers shown in FIGS. 1 and 2 represent prior art carriers. The carrier in FIG. 1 is made by Water Tot and a similar carrier, not shown, is made by Body Glove. FIG. 2 is a front view of the prior art carrier depicted in U.S. patent application Ser. No. 20050076856 A1. None of these prior art carriers have the design, construction or combination of materials that makes the carrier of the present invention superior to and patentably distinguishable from these prior art carriers as will be described below.

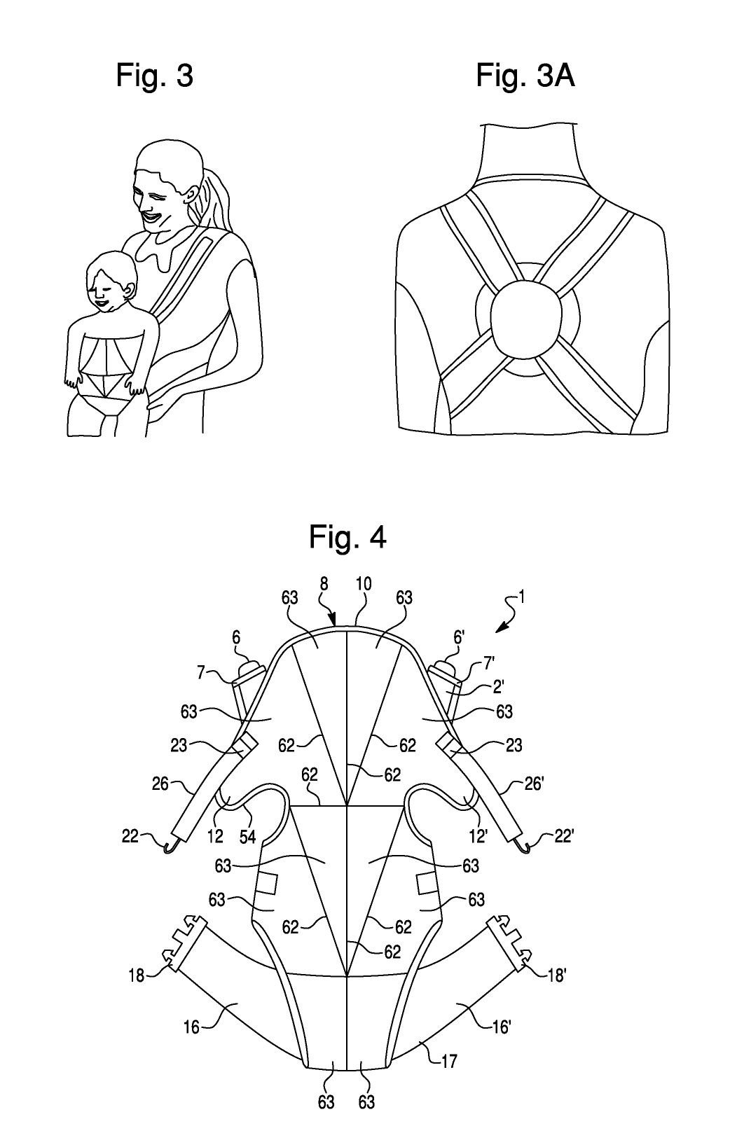

The carrier 1 shown in FIGS. 3-5 generally includes two main parts that are integrated into a single unit. Basically, the first of these parts is a fully adjustable, criss-crossed shoulder and back strap system including shoulder/back straps 2, 2′ worn by the adult caregiver and which distributes the weight of baby or infant being carried. The second of these parts is the main body 8 in which the infant or baby sits when the body 8 is appropriately folded.

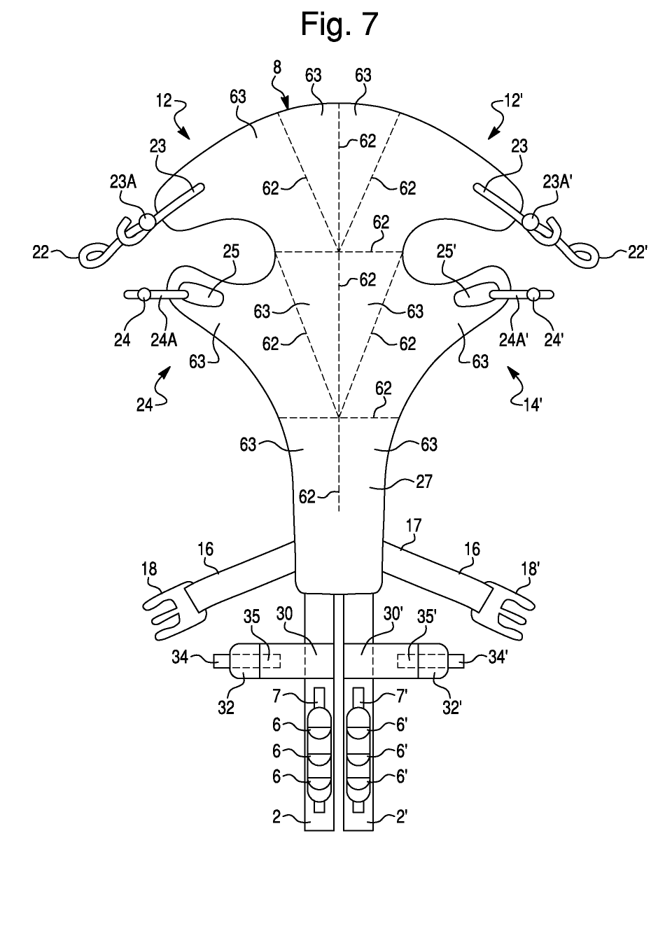

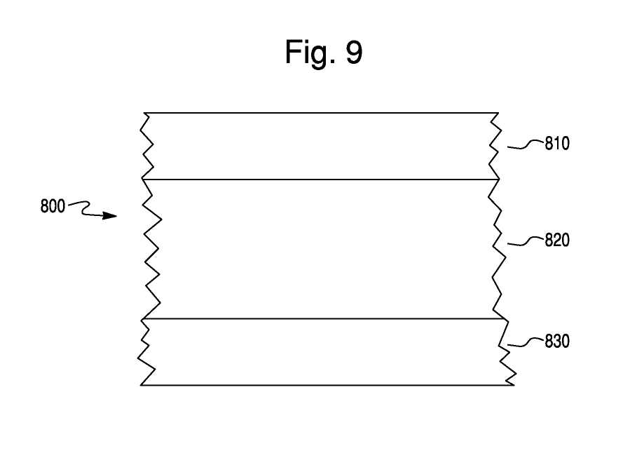

The main body 8, is soft and made to be positioned around the adult's midsection to allow the seated child to ride high on the adult's chest so that the adult's chin should be able to touch the top of the baby's head. Adjustment of the strap system having the straps 2,2′ with main body 8 can be carried out conveniently through lockable plastic buckles. Each strap 2, 2′ has a series of three spaced-apart plastic D-rings 6, 6′ secured on the outer sides of straps 2, 2′. The highest D-rings 6, 6′ are located where the straps rest on the adult's shoulders and the other two D-rings are spaced about three inches apart extending downwardly from the highest D-rings as seen in FIG. 4. D-rings 6, 6′ are secured to the side of shoulder/back straps 2, 2′ facing away from the adult by 1-inch wide straps 7, 7′ made of nylon webbing or polypropylene webbing or other suitable polymeric material as shown in FIG. 7. The child can be securely positioned in the bottom end of body 8 with the combination of buckles and Velcro pieces as will be described below. The carrier can be designed for the adult caregiver to slip on the adjustable shoulder/back straps 2,2′ over the adult's head and shoulders and the height adjustment is accomplished by swivel hooks being snapped onto the appropriate D-rings 6, 6′. The additional D-rings 6, 6′ may be used for hanging other useful items such as toys, and other baby items to them.

The carrier includes an adjustable head support 10 which is an integral part of the top portion of body 8 (FIGS. 3, 4, 7) that can be attached to the shoulder/back straps 2,2′ as will be described. Head support 10 as shown in the FIGS. is a solid area of the body 8. However, in an alternative embodiment to allow for more air flow around the baby's head and decrease perspiration, head support 10 could have shoelace-type eyelets mounted through the body across the area of the head support, as well as one or more mesh panels to allow more airflow. FIG. 7 shows the inside of the body 8 against which the baby rests. The body 8 has upper tabs 12, 12′ and lower tabs 14, 14′, which together form the openings through which the baby's arms can hang freely from the body 8. The upper tabs 12, 12′ have common type adjustable, plastic swivel hooks 22, 22′ secured to the tabs 12, 12′ by 1-inch wide nylon webbing straps 23, 23′ secured to tabs 12, 12′. Optional strap protectors 26, 26′ (see FIGS. 4 and 8) can be provided which slip over each strap 23, 23′ to make the area around the upper tabs 12, 12′ more comfortable for the baby. Protectors 26, 26′ are preferably made of neoprene or similarly suitable material for use in water. The upper tabs 12, 12′ of body 8 are secured by hooks 22, 22′ being snapped around the appropriate one of the D-rings 6, 6′, depending on the size of the baby being carried. Further adjustment can be accomplished by tightening the nylon webbing straps 23, 23′ using 1-inch strap adjusters 23A, 23A through which the nylon webbing straps 23, 23′ pass.

The lower tabs 14, 14′ have common snap-in type buckle ends 24, 24′ secured to the lower tabs 14, 14′ by ¾-inch wide nylon webbing straps 24A, 24A′, as well as Velcro pieces 25, 25′ secured to the inner side of the lower tabs 14, 14′ respectively. The lower portion of body 8 tapers into portion 27, which when folded up and back toward the head support 10 forms the seat for holding the child as will be further described.

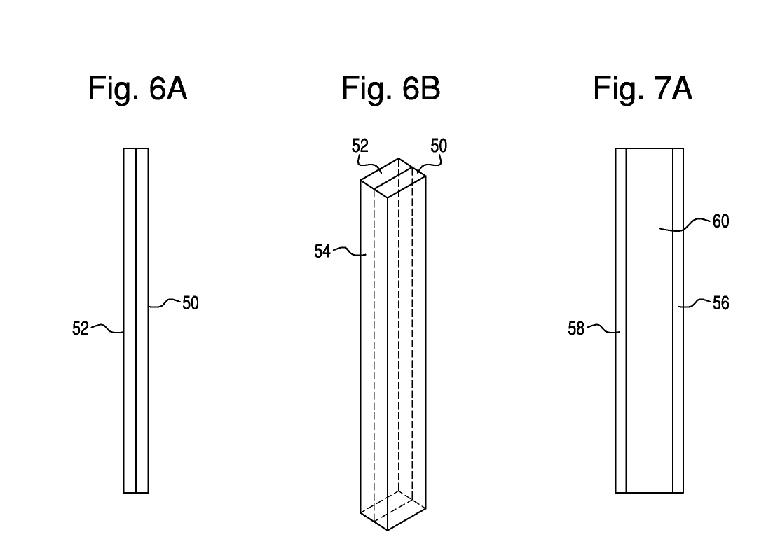

When the body portion 27 is folded forward and upward toward the head support 10, the lower portion 27 and the lower tabs 14, 14′ together form the openings through which the baby's legs extend out from body 8 and the place where the baby sits in the carrier. Also attached to the lower portion 27 is the nylon webbing waist strap 17, which has standard adjustable snap-in style buckles 18, 18′ attached at the ends 16, 16′ respectively thereof Buckles 18, 18′ are place around the waist of the adult toward the back to snap-in respectively to buckle ends 20, 20′ shown in FIG. 6 at the lower ends of shoulder/back straps 2,2′.

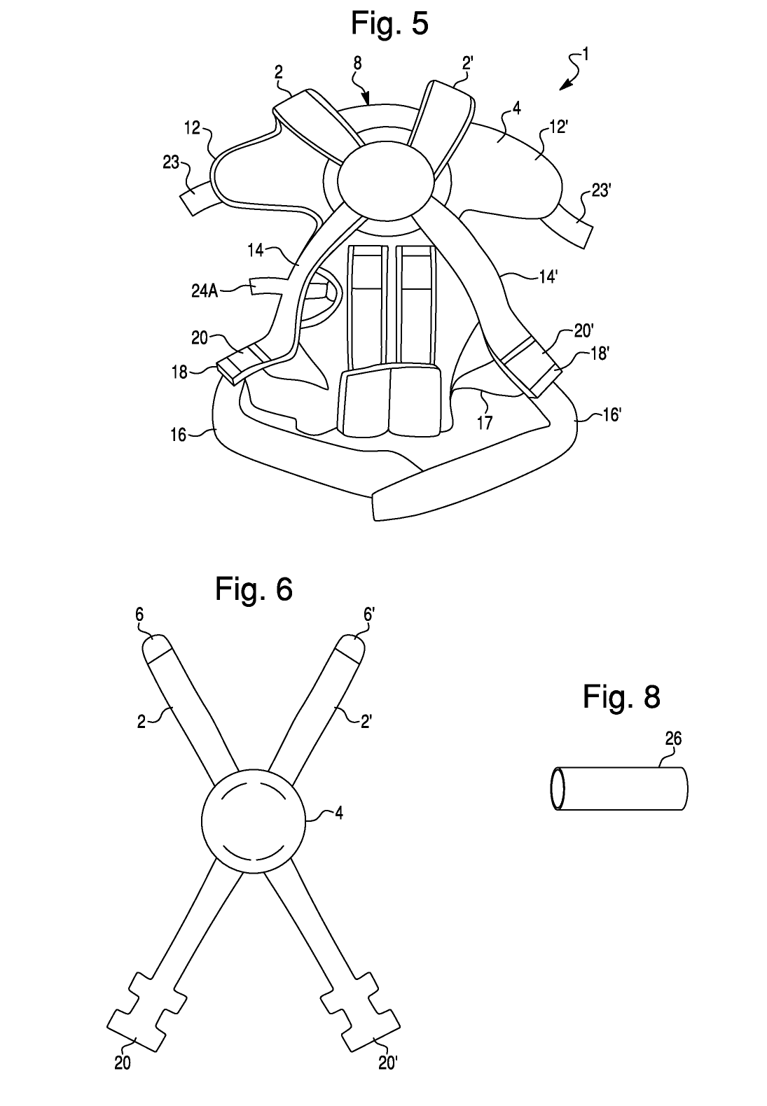

Extending from and secured to the lower portion 27 of body 8 are the other ends of straps 2, 2′ as seen in FIGS. 5, 6 and 8. Extending outwardly and secured to straps 2, 2′, between the lower portion 27 and D-rings 6, 6′, are 2-inch wide nylon webbing tabs 30, 30′ respectively. Tabs 30, 30′ have Velcro tabs 32, 32′ secured on the inner side next to the neoprene side of straps 2, 2′ and adjustable snap-in buckle ends 34, 34′ are respectively secured to tabs 30, 30′ by ¾ inch nylon webbing straps 35, 35′ on the same side of tabs 30, 30′ as the Velcro tabs 32, 32′. The view in FIG. 7 is of the outer nylon webbing side of straps 2, 2′, so that portions of the buckle ends 34, 34′ are shown in dotted form behind the nylon webbing side of tabs 30, 30′. Velcro tabs 32,32′ are also located on the inner sides of tabs 30, 30′ as seen in FIG. 7. When the lower portion 27 of body 8 is folded forward and upward, the buckle ends 34, 34′ are engaged to snap-in to the mating buckles 24, 24′ located on the lower tabs 14, 14′ of body 8 (see FIG. 5) and the Velcro tabs 32, 32′, each approximately 2-inches wide and 3-inches long, are secured to the mating Velcro tabs 25, 25′ respectively on the inner side of the lower tabs 14, 14′ of body 8. The combination of buckle ends 34, 34′ and buckles 24, 24′ and Velcro tabs 32, 32′ and 25, 25′ respectively provide a double locking mechanism for securing the lower portion 27 of body 8 to the lower tabs 14, 14′ to safely, snugly and securely hold the baby in the lower seat portion formed by body 8.

Although buckles 18, 18′ and 24, 24′, buckle ends 20, 20′ and 34, 34′, swivel hooks 22, 22′, and D-rings 6, 6′ are all shown as made of plastic, they could easily be made of metal, composites or other suitable lightweight, non-corrosive materials. Buckles 18, 18′ and buckle ends 20, 20′ are 2-inches wide and buckles 24, 24′ and buckle ends 34, 34′ are ¾-inches wide. The straps 16, 16′ and tabs 30, 30′ are made of 2-inch wide nylon webbing, straps 23, 23′ are made of 1-inch wide nylon webbing, and straps 24A, 24A′ are made of ¾-inch wide nylon webbing, but they could all be made of other suitable, non-stretchable materials, such as polypropylene webbing or other suitable polymeric material. The buckles and buckle ends, which are simple side release buckles, swivel hooks and D-rings are commercially available from the John Howard Company, Inc. of Chino, Calif.

The shoulder/back straps 2, 2′ are constructed of two layers as shown in FIG. 6A along the entire length of straps 2, 2′. The inner layer 50, which rests against the adult and is made of weather-resistant, synthetic, polymerized rubber, such as for example a 1.0 to 3-mm thick sheet of neoprene, secured face-to-face to an outer layer 52 which is made of a high-strength, resilient synthetic polymer, such as for example 2-inch wide nylon webbing. Waist strap 17 is 2-inches wide and is made of nylon webbing or polypropylene webbing. Outer layer 52 could also be made of polypropylene webbing or other suitable polymeric webbing. The nylon webbing and polypropylene webbing are commercially available from the John Howard Company, Inc. of Chino, Calif.

The two layers 50 and 52 of straps 2, 2′ are stitched together with an industrial strength thread and a polymer containing polyurethane edging 54 is wrapped around both outer edges of straps 2,2′ as seen in FIG. 6B. Edging 54 is made, for example, of spandex or Lycra, and is stitched along the edges of and through both the layers 50 and 52 to keep them securely attached together and to prevent fraying of the edges of layers 50 and 52. The inner layer 50 is made of thermoplastic resinous polymers that are a water buoyant fabric while in water, for example, neoprene. The outer layer 52 is made of a polymeric webbing material, such as nylon webbing, to give the straps 2, 2′ their carrying strength. Neoprene stretches too easily and cannot be used alone for the weight-bearing straps 2, 2′. By making the straps 2, 2′ of the neoprene layer 50 and nylon webbing layer 52, they are strong and provide more than adequate support for carrying the baby, while providing a quick-drying, non-mildewing and non-mold-forming material, through which water or body moisture is not trapped and moves easily through. When the carrier gets wet, because of the construction and particular materials used, it dries very quickly. Even if it gets dirty, sandy, or muddy, the carrier is completely washable and is cleaned very easily. The secure fit and convenience of hands free use ensures safety and comfort for both adult and baby.

The body 8 as seen in FIG. 7A is made of an inner layer 56, an outer layer 58, both made of a weather-resistant, synthetic, polymerized rubber, such as for example neoprene, of 1.0 to 3-mm thickness. Secured between layers 56 and 58 is a layer 60, made of an antimicrobial-coated foam of approximately one-half inch in thickness and of medium density. The edges of the three layers 56, 58 and 60 of body 8 are secured together just as straps 2, 2′ with a polymer containing polyurethane the same as edging 54 as seen in FIG. 6B, such as for example spandex or Lycra. The edging 54 is stitched all along the edges of and through both the layers 56, 58 and 60 all the way around body 8 to keep the layers securely attached together and to prevent fraying of the edges of layers 56, 58 and 60. The neoprene together with the open-cell foam, gives the carrier extra cushion, support and comfort for baby/toddler during all safe land and water activities, year round. The foam layer 60 has an antimicrobial coating that prevents mildewing and mold from growing. This foam is variously called dry foam, outdoor foam or open cell foam and is commercially available from various companies including Foamex InternationaL Inc. of Linwood, Pa. Foamex polyurethane foam is a fully cross-linked reaction product of polyhydroxy polyol, touluene di-isocyanate, catalysts, surfactants, pigments and water. Polyurethane foam is a polymeric material consisting of repeating units of carbon, hydrogen, oxygen and nitrogen. When the carrier 1 is in water or gets wet, the water passes into the interior of the outer neoprene layers 56 and 58 where the regular type of stitching of edges 54 is used when they are sewn together, but the anti-microbial coated foam layer 60 does not soak up the water. Therefore, the carrier dries very quickly. The open cell foam layer 60 does not hold or soak up the water like a sponge. Foam 60 generally takes the form of a piece of rubber that has been shaved at different thicknesses and can have many different types of fabric laminated to it, such as the nylon and lycra used for the strapping and edging of the carrier. When the carrier is sewn together using regular stitching, the holes from the stitching, though allowing small amounts of water to enter, because of the open cell foam, water is not held by or soaked up by the foam.

Another alternative to regular stitching is to completely seal the outer edges of body 8 and stitching 62 so that no water passes through the outer edges of body 8 or through the stitching so it is completely water-tight. Edge sealing can be accomplished by flatlock stitching to provide breathable seams. Flatlock stitching is serging two layers of fabric together, then pulling them apart until the seam lies flat. It takes some experimentation to get the tension just right. Too loose a tension and the seam pulls away, too tight and it is difficult to get the seam to lay flat. Another way to accomplish a flatlock-type stitch is as follows. Serge the edges of the seams to be joined, trimming off the seam allowance. Place the two serged edges together, then using a zig-zag stitch, sew the two sides together. Sometimes it may be desired to use a three step zig-zag; this creates a sturdier seam, but flattens the serging more. This flatlock-type seam will be considerably wider than normal flatlocking, but in some cases the trade off may be worth the ease of completion. If desired, a decorative thread made of nylon can be used to zig-zag the seam for added texture. It is also possible to seal the outer edges of body 8 using a no stitch technology and a 4 mm Metallite neoprene, laminated with a Diamond-Tuff nylon construction system where not a single stitch is used to seal the outer edges of body 8. This type seal is commercially available and is described at http://www.naval-technology.com/contractors/diving/fitzwright/, which description is incorporated herein by reference.

The body of the carrier 1 is first sewn together using a straight stitch leaving the bottom end of lower portion 27 open approximately 3 inches. The edges are then bound with lycra trim. The antimicrobial-coated foam is stuffed through the bottom making sure the foam lays flat against the inside edges of the carrier 1. Once the foam is flat and smooth it is stitched all around the edges of body 8 and held in place using specific stitching lines 62 as shown on the pattern in FIG. 7. It is the stitching that creates quilted sections 63 on the body 8 as seen in FIG. 7 that gives strength to the body 8 of the carrier by allowing for minimal stretch. Without this the carrier would stretch too much and loose its shape.

The materials needed for manufacturing the carrier 1 are as follows:

a. Carrier Pattern--the body member of the carrier is 17 inches wide and 22½ inches long.

b. Neoprene Fabric (1.0-4 mm thick), 50, 56, 58

c. Open-Cell Outdoor Foam (medium density, ½ in. thick), 60.

d. 2 inch Nylon or Polypropylene Webbing, 2, 2′, 16, 16′

e. 1 inch Nylon or Polypropylene Webbing, 23, 23′

f ¾ inch Nylon or Polypropylene Webbing, 24A, 24A′

g. (2) 2 inch Side Release Buckles, 18, 18′

h. (2) ¾ inch Side Release Buckles, 24, 24′

i. (2) 1 inch Strap Adjusters, 23A, 23A′

j. (6) 1 inch D-Rings, 6, 6′

k. (2) 1 inch Swivel Snap Hooks, 22, 22′

l. (2) 2 inch Velcro, 3 inches long, 25, 25′

m. Lycra trim, ¼ inch

n. Scissors

o. Pins

p. Industrial Strength Thread

q. Heat (to fuse all webbing ends-avoid fraying).

r. Industrial Sewing Machine and attachments to apply trim.

The following materials must be prepared prior to final assembly of the carrier:

a. Cut 2 Neoprene pieces out of Pattern A.

b. Cut 1 Open-Cell Outdoor Foam piece out of Pattern B.

c. Cut 2 pieces of 3/4 inch Webbing, each being 6 inches long (for ¾ inch Side Release Buckle ends 34, 34′ on Arm 2 of Pattern A).

d. Cut 2 pieces of 3/4 inch Webbing 24A, 24A′, each being 3 inches long(for ¼ in. Side Release Buckles 24, 24′ attached to Lower Tabs, 14, 14′).

e. Cut 2 pieces of 1 inch Webbing, 23, 23′ each being 10 inches long (for Strap Adjusters 23A, 23A′ and Swivel Hooks 22, 22′ on Arm 1A and Arm 1B).

f. Cut 1 piece of 2 inch Webbing, 48 inches long for waist strap 17.

g. Cut 2 pieces of the 1 inch Webbing, each being 8 inches long for straps 7, 7′ for attaching D-Rings 6, 6′ to straps 2, 2′.

h. Cut 2 pieces of 2 inch Hook and Loop Velcro 25, 25′ and 32, 32′, 4 inches long for Lower Tabs 14, 14′ and strap Velcro tabs 25, 25′.

i. Tabs 30, 30′ for Shoulder Straps: Cut 2 pieces of 2.times.3½ inches of Neoprene.

j. Next, cut 2 Neoprene Straps 50, being 2 inches wide.times.38 inches long.

k. Cut 2 Nylon Webbing Straps 52 out of 2 inch Nylon Webbing, each being 38 inches long.

l. Heat and fuse all Webbing ends after cutting, in order to prevent fraying. [0093]

m. Cut out 1 4 mm thick Neoprene Back Stablizer piece 4 from the Back Stablizer Pattern piece.

n. Then, cut out the (4) 2½ inch openings in the Back Stablizer Pattern, which is where the Shoulder Straps 2, 2′ go through (See FIG. 5).

Once the above materials have been created, then the following steps are followed to assemble the carrier into finished form:

a. Trace, with the erasable sewing chalk, the top stitching on Pattern A (only one side of Neoprene).

b. Lay both pieces of neoprene body 56 and 58 (wrong sides together), matching all edges (the piece with the seamline tracings will be considered the right side of the neoprene. Using trim edging 54, sew ¼ inch lycra trim around edges, leaving bottom open. If a water-tight seal is desired, this is where the flatlock stitching techniques described above may be used. Take the Open-Cell Foam piece 60, and place it between the 2 Neoprene pieces 56 and 58 of Pattern A, with the back sides together. Carefully stuff foam in bottom opening of body member 8, making sure foam is fitted into all corners and curves.

c. Topstitch tracings, working from the center to the outer edge (this holds foam in place), thus forming the quilted sections 63 as seen in FIGS. 4 and 7.

d. Leave the bottom Center Line open 2½ inches from the bottom until the Waist Strap 17 is ready to be placed.

e. Assemble upper tab straps 23, 23′ as follows: Using 1 inch webbing, 10 inch long straps 23, 23′, turn under ¼ inch on one end and stitch. Place each strap 4 inches from the end of upper tabs 12, 12′ in the middle. Stitch in place, stitch again ½ inch from first stitching, and again 1 inch on end of each strap twice, and stitch securely in place. Run each strap 23, 23′ through the swivel hooks 22, 22′ and then through 1 inch Strap Adjusters 23A, 23A′.

f. Assembly of lower tab 14, 14′ Velcro tabs 25, 25′ and buckles 24, 24′:

Using the soft ½ of the velcro (loop side), cut from pattern piece “T” shorten straight end by 1½ inch. Total Length should be 2½ inches. Position on lower tabs 14, 14′ (solid black side), and stitch around all edges. Repeat for both tabs (See FIG. 7).

g. Placement of ¾ inch buckles 24, 24′ on outside facing of piece of lower tabs 14, 14′: Turn under ¼ inch of end of ¾ inch.times.6 inch of piece of webbing 24A, 24A′ and stitch. Place 3 inch in from curve of lower tabs 14, 14′. Stitch securely in place, and stitch again ¼ inch from previous stitching. Run webbing 24A, 24A′ through ¾ inch end of side release buckles 24, 24′. Turn under ¼ inch end of webbing.times.2, and stitch in place.

h. Shoulder/Back Straps 2, 2′:

1. Sew 2 inch.times.38 inch neoprene (2 mm) 50 to 2 inch×38 inch nylon webbing 52 (repeat for other strap). Place correct use and care instructions label on neoprene side of one shoulder/back strap 2 or 2′. Sew around all edges.

2. Sew ¼ inch lycra trim edging 54 around all edges of straps 2, 2′.

3. Put end of each strap through female buckle end 20, 20′. Turn under ½ inch to neoprene side 50 and stitch.

4. Assemble Tabs: Using previously cut hook side of Velcro 32, 32′ from pattern “T.” Stitch together velcro tabs 32, 32′ and nylon webbing tabs 30, 30′ (previously cut from pattern “t”). Sew ¼ inch lycra trim edging 54 around all edges. Place ¾ inch×3 inch nylon webbing through the female buckle ends 34, 34′ of side release buckles, folding webbing evenly. Place on nylon side of tabs 30, 30′ (5 inches from end of straps, sew around edges), enclosing buckle ends 34, 34′ between straps 2, 2′ and tabs 30, 30′.

i. Placement of D-rings 6, 6′, with 3 on each strap 7, 7′, using 1 inch×8 inch piece of nylon webbing.

1. Turn under each end of strap 7, 7′ ¼ inch and stitch. Place end of straps, 7, 7′ 2½ inches above tab. Stitch securely in place.

2. Slide on one D-ring 6, 6′ and stitch above D-ring.

3. Stitch 3 inches from previous stitching. Place 2nd D-ring 6, 6′ and stitch above 2nd D-ring.

4. Stitch 3 inches from previous stitching. Place 3rd D-ring 6, 6′ and stitch securely (see FIG. 7).

j. Waist Straps:

1. Fold in half the 2 inch×48 inch piece of webbing strap 17, mark the center.

2. Place center of webbing strap 17 in open lower end of carrier. Fold webbing.

3. Place the neoprene straps 50 with tabs 30, 30′ in opening at the bottom of carrier (nylon side with D-rings facing up). Secure end of straps 2 inches inside carrier, sew edges down. Close top flap of carrier and stitch around edges.

4. Run male end of 2 inch side release buckles 18, 18′ through ends 16, 16′ of waist strap 17. Turn over ¼ inch end×2 and stitch securely in place.

k. Run shoulder straps through slots in back strap holder 4 (see FIGS. 3A and 5).

1. If desired, all the stitching may be accomplished with flatlock stitching techniques to create a completely water-tight product.

The child is held securely in the carrier in seat formed in the lower part of body 8. The carrier is designed for small children with and without neck control. For infants or other special needs children who do not have neck control, the head support 10 built integral with body 8 is provided. The head support can also be used when the baby is place in the carrier to face the adult.

The carrier 1 is used and adjusted as follows. The shoulder straps 2, 2′ are placed over the adult's head with the body 8 positioned on the adult's chest and the strap stabilizer 4, made of 4 mm thick neoprene, resting flat on the adult's back between the bottom ⅓ of the adult's shoulder blades. See FIG. 3A. The left and right waist buckles 18, 18′ are snapped into the buckle ends 20, 20′ on the ends of straps 2, 2′. The ends of straps 2, 2′ are then pulled until the carrier fits snugly against the adult's body. Before the baby is placed in the carrier, the waist buckles 18, 18′ are fastened and tightened. One side of the carrier is completely fastened. This is accomplished by ensuring that buckle 24 on lower tab 14 is snapped into buckle end 34 of tab 30 and Velcro tab 32 is engaged with Velcro tab 25 on the inside of lower tab 14 of body 8. If preferred the other side could be fastened instead. Then the open side of the carrier is closed. This is accomplished by first attaching Velcro tab 32′ on tab 30′ to the Velcro tab 25′ on the inside of lower tab 14′ of body 8. Buckle 24′ is then snapped into buckle end 34′ on the end of tab 30, closing the buckle 24′ over the Velcro engaged tabs 32′ and 25′. Upper tab 12′ is then attached to shoulder/back strap 2′ by latching the swivel hook into D-ring 6′. Further adjustment of the carrier is provided, depending on which of the three D-rings 6, 6′ the swivel hooks 22, 22′ are attached. The end of nylon webbing strap 23′ is pulled on to tighten and adjust the fit.

The baby is then placed in the carrier through the open side, making sure the baby's arms are through the armholes formed between the upper tabs 12, 12′ and lower tabs 14, 14′ of body 8. Check to make sure that the back and waist are securely buckled. Pull straps 16, 16′, 23, 23′ and 24A, 24A′ so as to provide a secure and snug fit.

The baby may be placed in the carrier facing in toward the adult. First attach Velcro tabs 32, 32′ and 25, 25′ respectively. Fasten buckles 24, 24′ into buckle ends 34, 34′ to ride over the engaged Velcro tabs. Latch one side of the carrier by fastening swivel hook 22′ of upper tab 12′ to D-ring 6′ on shoulder strap 2′. Pull on the end of nylon webbing strap 23′ to adjust the fit. Making sure the openings for the legs on both sides are open and that buckle 18′ is snapped into buckle end 20′ on strap 2, pull on the waist strap end 16′ to ensure a snug fit. Adjust the carrier until the baby rides high on the adult's chest. The adult's chin should be able to touch the top of the baby's head. By placing the carrier high on the adult's chest the stress on the adult's lower back is reduced.

The baby may also be placed in the carrier facing outward away from the adult. This position is appropriate for babies that are able to hold their heads and shoulders in an upright position. Place the baby in the carrier facing out through the open side. Make sure the baby's legs straddle the seat formed at the bottom of body 8. In this position the head support 10 portion of the body 8 should be folded down about 4 inches so that the baby's arms are over the armholes that would normally be formed by upper and lower tabs 12, 12′ and 14, 14′. Attach the Velcro tabs 32′ on tab 30′ and 25′ on the inside of lower tab 14′ of body 8. Fasten buckle 24′ into buckle end 34′ on tab 30′ so that the buckle rides over the fastened Velcro tabs 32′ and 25′. Latch the upper tab 12′ by fastening swivel hook 22′ to D-ring 6′. Further adjustment of the carrier is provided, depending on which of the three D-rings 6, 6′ the swivel hooks 22, 22′ are attached. Adjust upper and lower tabs 12, 12′ and 14, 14′ respectively by pulling on the ends of straps 23, 23′ and 24A, 24A′ so that the baby's back fits snuggly against the adult's chest. For smaller babies, the baby's arms should go through the armholes formed by upper and lower tabs 12, 12′ and 14, 14′ of body 8. For larger babies with good upper body control, the arms can rest over the folded-over upper tabs 12, 12′ and head support 10. Adjust straps 16, 16′, 23, 23′ and 24A, 24A′ as necessary to ensure a snug fit.

FIG. 9 shows a cross-section of a high performance material 800 in accordance with an embodiment of the invention. FIG. 9 shows a top layer 810 and a bottom layer 830. Secured between the top layer 810 and the bottom layer 830 is layer 820 which is made of an antimicrobial-coated foam. As will be described in greater detail below, the antimicrobial foam may be an open-cell or closed cell structure and has an antimicrobial coating that prevents mildew and mold from growing. The top layer 810 and bottom layer 820 may be constructed from a variety of materials and may be breathable or non-breathable, and water resistant or water accommodating and fire resistant (non-flammable). The term “breathable” refers to the material having pores large enough to allow water vapor molecules to pass through, thus allowing water to pass from one side of the material to another. It should also be noted that the top layer 810 and the bottom layer 830 may be a single uniform layer or may include various sub-layers having different materials. The use of a variety of sub-layers may provide enhanced properties or a combination of desired properties. Thus, for example, the top layer 810 and/or the bottom layer 830 could include two or more sub-layers of material that provide different features but collectively form a layer having many desirable properties.

In one embodiment, the top layer 810 and the bottom layer 830 may be constructed from breathable neoprene which may have anti-microbial properties and is moisture accommodating, durable, easy to dry and easy to clean. Breathable neoprene is particularly desirable for use in warm weather and water activities because air and moisture freely flow through the material. In another embodiment, the top layer 810 and the bottom layer 830 may be constructed from non-breathable neoprene which may also have anti-microbial properties and is moisture resistant, durable, easy to dry and easy to clean. Non-breathable neoprene is desirable for use in water and cold weather because it serves to resist water and retain heat.

The top layer 810 and the bottom layer 830 may also be constructed from breathable bamboo neoprene which has anti-microbial properties, is moisture accommodating, easy to use, easy to clean and dries quickly. Breathable bamboo neoprene is particularly desirable for use in warm weather and water activities because air and moisture freely flow through the material. In another embodiment, top layer 810 and bottom layer 830 may be constructed from non-breathable bamboo neoprene which also has anti-microbial properties, is moisture resistant, easy to use, easy to clean and dries quickly. Non-breathable bamboo neoprene is preferred for uses in water and cold temperatures because is serves to resist water and retain heat. Bamboo fabrics as described herein may include bamboo blends, such as bamboo charcoal materials. Bamboo blended materials may offer further advantages through the addition of other materials with bamboo.

Bamboo fabrics such as breathable and non-breathable bamboo neoprene are natural textiles made from the pulp of bamboo grass. Thus, bamboo fabrics are made from natural renewable sources, are biodegradable and therefore are considered eco-friendly products. Bamboo fabric is also favored by companies trying to use sustainable textiles, because the bamboo plant is very quick growing and does not usually require the use of pesticides and herbicides to thrive. As a result, bamboo farms can easily be kept organic and replanted yearly to replenish stocks.

In textile form, bamboo retains many of the properties it has as a plant. Bamboo is highly water absorbent, able to take up three times its weight in water. This translates to excellent wicking ability that will pull moisture away from the skin so that it can evaporate. For this reason, clothing made of bamboo fiber is often worn next to the skin. As described above, bamboo also has many naturally occurring antibacterial qualities which it is able to retain, even through multiple washings. This helps to reduce bacteria that forms on clothing which may cause unpleasant odors. Bamboo fabric also has insulating properties and will keep the wearer cooler in summer and warmer in winter.

The top layer 810 and the bottom layer 830 may also be constructed from breathable limestone neoprene which has anti-microbial properties, is moisture accommodating, easy to use, easy to clean and dries quickly. Breathable limestone neoprene is best for warm weather applications because air and moisture freely flow through the material. In another embodiment, the top layer 810 and the bottom layer 830 may be constructed from non-breathable limestone neoprene which also has anti-microbial properties, is moisture resistant, easy to use, easy to clean and dries quickly. Limestone based neoprene is generally considered eco-friendly because it is derived from over 99.0% calcium carbonate which can be mined or derived from shells, as compared with traditional neoprene materials which are derived from petrochemicals.

The top layer 810 and the bottom layer 830 may also be constructed from various materials which have been treated with nano-particles, such as, but not limited to Nanotex TM and fabrics manufactured by Nanogate AG. Nano-sized particles may be applied to a top surface of a material to provide various advantageous properties including: UV protection, water-resistance, quick drying, quick cleaning, easy to clean and increased performance. Nano-treated materials may also be breathable and antimicrobial. Nano-treated fabrics may be treated with a variety of materials, such as colloidial nano-silver, titanium dioxide and zinc oxide, which provide anti-bacterial properties, and nano-silicone materials which enhance the softness and flexibility of the fabric.

The top layer 810 and bottom layer 830 may also be constructed from polyamide (nylon) materials, Lycra, cotton, soy based materials, recycled polyester, recycled PET (polyethylene tetraphthalate) and microfiber all of which are breathable, moisture-regulating, durable, easy to clean and quick drying. In another embodiment, the top layer 810 and the bottom layer 830 may be constructed from various materials available from third party vendors, including: “Sun Dry Swim™,” “Klymit,” materials manufactured by Schoeller and “Stomatex® brand neoprene. The “Sun Dry Swim™” material is a nanotechnology enhanced swimwear fabric that is breathable, stretchable, fast drying, moisture resistant and water resistant. “Klymit” is an insulative material that is made using noble gases. Schoeller materials include combinations of cotton. Lycra, microfiber, polyamides, viscose, eco-tex water repellant and dirt-repellant materials. Stomatex® neoprene is a high-performance fabric made from a lightweight, ultra-thin, non-porous polyester membrane that is weatherproof and highly breathable. Stomatex® materials use a pattern of dome-shaped vapor chambers, each with a tiny pore in the center. The material permits excess body heat and perspiration to rise into the dome-shaped chambers and exit through the tiny pores at a controlled rate. The chambers flex and stretch with each movement of the body, causing excess heat and perspiration to be pumped out of the small pores. This also allows cooler, drier air to enter from the outside.

In another embodiment of the invention, a breathable, waterproof coating may also be applied to the outer surface of the top and bottom layers 810 and 830.

As described above, layer 820 is constructed from an open or closed cell foam material which is treated so that it has anti-microbial properties. Layer 820 may also be referred to as an insulating layer and provides cushioning (energy absorbing) properties to the high performance material 800. It should also be understood that the layer 820 could be formed with multiple sub-layers of open or closed cell foam whereby each sub-layer has specific characteristics.

In general, open-cell foam is soft, breathable and allows the transmission of water vapor. The open cell material may be a polyurethane foam (either thermoplastic or thermoset) or comparable material. Preferably, the open cell foam has a thickness between 1/16 inch and 3 inches. It should be understood that that the open cell foam thickness can also be greater than 3 inches through the layering of multiple pieces of foam material.

Closed-cell foam has varying degrees of hardness, depending on its density. A typical closed-cell insulation or flotation polyurethane is between 2 and 3 pounds per cubic foot. Typical closed cell foam materials are strong and rigid and can withstand significant pressure without deforming. In one embodiment, the closed cell foam can have a thickness of 1/16 inch or greater.

The layers 810, 820 and 830 are inter-connected to form a unitary high performance material 800 through various techniques. In one embodiment, the layers 810, 820 and 830 are sown together using regular stitching techniques. When the layers 810, 820 and 830 are sown together in this manner, holes from the stitching may permit a small amount of water to seep through. However, if the layer 820 is made from an open cell foam, then water is not held or soaked up by the foam

The high performance material 800 may also be stitched together so that the outer edges of the material 800 are sealed. In this case, if the top and bottom layers 810 and 830 are water resistant/waterproof, then water will not penetrate the material 800 resulting in a water-tight material. The edges can be sealed through flatlock stitching so as to provide breathable seams. As described above, flatlock stitching involves serging two layers of fabric together, then pulling them apart until the seam lies flat.

In another embodiment, the layers 810, 820 and 830 can be stitched in such a manner to create quilted sections. This provides the material 800 with added strength.

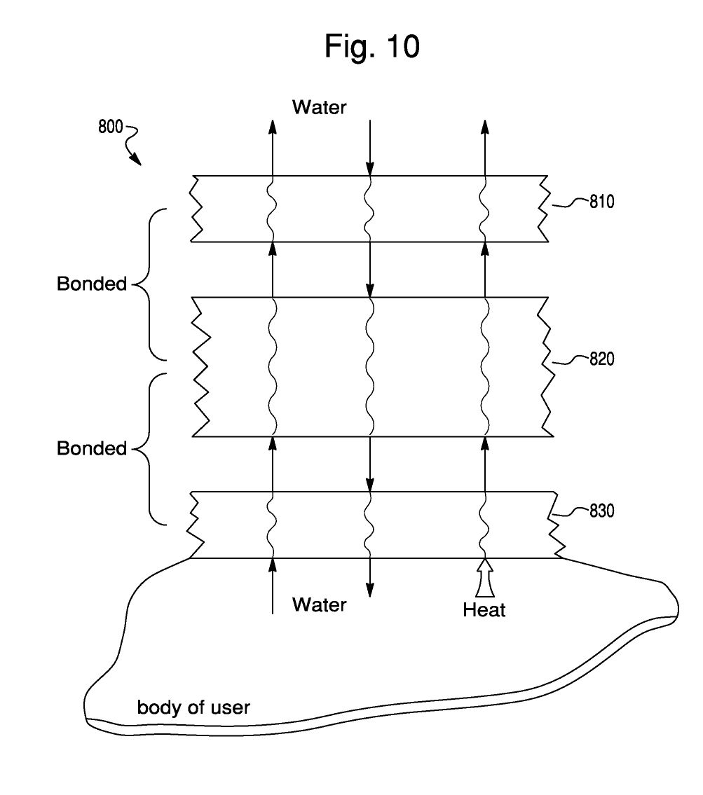

FIG. 10 shows an exploded view of the high performance material 800 according to an embodiment of the invention. FIG. 10 shows the top layer 810, the insulating layer 820 and the bottom layer 830 of the high performance material 800 as separated for illustrative purposes. In this embodiment, the top and bottom layers 810, 830 are constructed from a breathable material, such as any of those described above in connection with FIG. 9. Also in this embodiment, the insulating layer 820 is constructed from a breathable foam. FIG. 10 indicates that the layers 810, 820 and 830 are bonded together. The term bonded refers to any mechanism for connecting the adjacent layers of material, including stitching them together, using various fasteners and/or using adhesive materials to hold the layers together. FIG. 10 also shows the high performance material 800 placed against the skin of a user. FIG. 10 indicates that heat from the body of the user is wicked away from user's body through the layers 830, 820 and 810. The arrows in FIG, 10 also indicate that water flows through the layers 810, 820 and 830. Thus, the high performance material 800 does not retain water which would weigh down the material and promote the formation of mold and mildew.

Although the carrier shown in the FIGS. describe and show a baby carrier for carrying the baby in the front of the adult, modifications could be made by those skilled in the art so that a carrier containing the unique and novel combination of elements of the present invention could be incorporated in a back carrier or side carrier to be worn on the adult's side body. The combination of design, construction and materials of the present invention could also be used by those skilled in the art to make other types of carrying devices for amphibious use on land and in water. The fact that the neoprene is quilted with the foam in between the neoprene layers gives it strength and comfort and makes it applicable to other items such as snow and winter apparel, beach and sun apparel, diaper bags, beach bags, and physical fitness accessories, such as gym bags and the like.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A high performance material, comprising:
an insulating layer formed from one of an open-cell foam and a closed-cell foam, the insulating layer having a top side and a bottom side;
a top layer formed adjacent the top side of the insulating layer; and
a bottom layer formed adjacent the bottom side of the insulating layer.

2. The high performance material according to claim 1, wherein the top layer is formed from at least one of a breathable neoprene, a non-breathable neoprene, a breathable bamboo, a non-breathable bamboo, a breathable limestone, a non-breathable limestone, a polyamide, Lycra, cotton and microfibre.

3. The high performance material according to claim 1, wherein the bottom layer if formed from at least one of a breathable neoprene, a non-breathable neoprene, a breathable bamboo, a non-breathable bamboo, a breathable limestone, a non-breathable limestone, a polyamide, Lycra, cotton and microfibre.

4. The high performance material according to claim 1, wherein the top layer is formed from at least one of a Nano-tex™, Klymit, Sun Dry Swim™ and Stomatex® neoprene.

5. The high performance material according to claim 1, wherein the bottom layer is formed from at least one of a Nano-tex™, Klymit, Sun Dry Swim™ and Stomatex® neoprene.

6. The high performance material according to claim 1, wherein the open and closed cell foam are treated with an antimicrobial agent.

7. The high performance material according to claim 1, wherein the top layer and bottom layer are treated with an antimicrobial agent.

8. The high performance material of claim 1, wherein the top and bottom layers are water resistant.

9. The high performance material of claim 1, wherein the top and bottom layers are water accommodating.

10. The high performance material according to claim 1, wherein the top and bottom layers are UV ray resistant.

11. The high performance material according to claim 1, wherein the top and bottom layers are treated with nanoparticles.

12. The high performance material according to claim 1 wherein the top layer, insulating layer and bottom layer are stitched together to form a water-tight body.

13. The high performance material according to claim 1, wherein a stitching pattern is formed through the top, intermediate and bottom layers forming quilted sections.
